(19) United States
(12) Patent Application Publication
(10) Pub. No.: US 2016/0377367 A1
(43) Pub. Date: Dec. 29, 2016

(54) LIGHT-TAG SYSTEM

(71) Applicant: ILJ CORPORATION, NORTH CHESTERFIELD, VA (US)

(72) Inventors: JOHN MERRILL DAVIS, III, MIDLOTHIAN, VA (US); JANE DORNBUSCH DAVIS, MIDLOTHIAN, VA (US); MARK W. KITCHEN, HENRICO, VA (US)

(21) Appl. No.: 15/177,549

(22) Filed: Jun. 9, 2016

Related U.S. Application Data
(60) Provisional application No. 62/183,958, filed on Jun. 24, 2015.

(51) Int. Cl. F41A 33/02; F41G 3/26; F41J 5/02; H04B 10/114

(52) U.S. Cl. CPC F41A 33/02; H04B 10/114; F41G 3/2655; F41J 5/02

(57) ABSTRACT

A multi-player, indoor human light-tag game system includes as game elements additional non-human players in the form of one or more computer-controlled aircraft with the abilities to shoot and be shot via light by the human players, thereby creating a novel game very different from conventional light-tag.

### CROSS-REFERENCE TO RELATED APPLICATIONS

This application claims priority to U.S. Provisional Application Serial No. 62/183,958, filed Jun. 24, 2015, the contents of which are incorporated herein by reference in its entirety.

### FIELD OF THE INVENTION

Embodiments of the invention relate generally to an indoor light-tag system and more particularly to a light-tag system incorporating aircraft having hardware and intelligent abilities enabling them to serve as non-human players.

### BACKGROUND OF THE DISCLOSURE

Light-tag is a well-established, commercial, multi-player competitive recreational game typically played in darkened arenas with special equipment for each human participant comprising an electronic vest and shooting device which enables them to shoot one another and (optionally) other fixed objects and thereby accumulate points. Electronics are employed that create and detect coded light signals, rather than projectiles, to establish target “hits” and maintain individual and team scores. Originally designed with lasers, many non-laser versions now exist, some with the coded light signals emanating from the shooting devices and others with coded light signals emanating from the targets.

### BRIEF SUMMARY

It is the primary object of the present invention to provide a light-tag game system incorporating computer-controlled aircraft with light-tag capabilities which physically maneuver and shoot human players and which can themselves be shot, thereby creating a new game.

Briefly stated, one aspect of the present disclosure is directed to a light-tag system comprising a human-wearable garment comprising at least one target, a human-controlled targeting device associated with the garment, and a computer-controlled aircraft comprising at least one target and at least one targeting device. Each of the at least one aircraft targeting devices is adapted to detect if one of the at least one garment targets is in the respective field of view of the at least one aircraft targeting device. The human-controlled targeting device is adapted to detect if one of the at least one aircraft targets is in the field of view of the human-controlled targeting device when the human-controlled targeting device is activated by a user.

The human-wearable garment may be a first human-wearable garment and the human-controlled targeting device associated with the garment may be a first human-controlled targeting device associated with the first garment. The system may further comprise a second human-wearable garment comprising at least one target and a second human-controlled targeting device associated with the second garment. The first human-controlled targeting device may be adapted to detect if one of the at least one targets of the second human-wearable garment is in the field of view of the first human-controlled targeting device when the first human-controlled targeting device is activated by a first user. The second human-controlled targeting device may be adapted to detect if one of the at least one targets of the first human-wearable garment is in the field of view of the second human-controlled targeting device when the second human-controlled targeting device is activated by a second user.

If an aircraft targeting device detects that one of the garment targets is in the field of view of the aircraft targeting device, the aircraft targeting device may be adapted to selectively transmit a coded message to the garment and/or the targeting device associated with the garment, the coded message informing the garment and/or the garment targeting device that the aircraft targeting device detected the garment target.

If the human-controlled targeting device detects that one of the aircraft targets is in the field of view of the human-controlled targeting device when the human-controlled targeting device is activated by a user, the human-controlled targeting device may be adapted to transmit a coded message to the aircraft, the coded message informing the aircraft that the human-controlled targeting device detected the aircraft target.

The human-controlled targeting device may comprise at least one target.

Each target of the human-wearable garment and each target of the aircraft may emit coded infrared light.

The aircraft may be adapted to navigate about a three-dimensional game space by optically locating one or more light-emitting reference beacons and/or one or more objects in the game space and/or one or more visual features of the three-dimensional game space. The aircraft may comprise an imaging module, a memory module, and a controller. The controller may be adapted to compare images captured by the imaging module to a map of the game space stored in the memory module.

The aircraft may be adapted to fly within one or more virtual tunnels defined in a three-dimension game space. The system may further comprise (i) one or more additional computer-controlled aircraft, each comprising at least one target and at least one targeting device, (ii) one or more additional human-wearable garments, each comprising at least one target, (iii) one or more additional human-controlled targeting devices, each associated with a respective additional garment, and (iv) a central computer in radio communication with each aircraft and each garment. Each aircraft may be adapted to fly within its own respective virtual tunnel, or two or more aircraft may be adapted to fly within a shared virtual tunnel. The central computer may be adapted to communicate an assignment of a bounded section of the one or more virtual tunnels to each respective aircraft, each bounded section being unique to its respective aircraft. Each aircraft may be adapted to fly only within its respective bounded section. Each bounded section may move relative to its virtual tunnels over time.

The system may further comprise a central computer in radio communication with the aircraft. The central computer may be adapted to communicate a mathematical equation to the aircraft that enables the aircraft to continually compute assigned coordinates for a center of operation. The aircraft may be adapted to fly within a specified maximum distance from the center of operation.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a diagrammatic view of elements comprising a light-tag system incorporating multicopters as non-human players.

FIG. 2 is a diagrammatic view of a vest-pack design which may be used with embodiments of the invention.

FIG. 3 is a diagrammatic view of a fixed-position base which may be used with embodiments of the invention.

FIG. 4 is a diagrammatic view of a game control computer which may be used with embodiments of the invention.

FIG. 5 is a diagrammatic view of a computer-controlled multicopter which may be used with embodiments of the invention.

FIG. 6 illustrates of a method for constructing and using a system of ceiling navigational light targets in an embodiment of the invention.

FIG. 7 is a diagram of a “mathematical tunnel in the air” (tunnel) control strategy which may be used with embodiments of the invention.

FIG. 8 is a diagram of an overhead view of a typical flight path for a multicopter incorporating tunnel control strategy.

FIG. 9 is a functional diagram denoting a specific portion of the prior art of unmanned physical and computational elements common to unmanned multirotor multicopters.

FIG. 10 depicts at least some of the principle novel software functions of embodiments of the invention.

### DETAILED DESCRIPTION OF THE DISCLOSURE

Certain terminology is used in the following description for convenience only and is not limiting. Unless specifically set forth herein, the terms “a,” “an” and “the” are not limited to one element, but instead should be read as meaning “at least one.” The terminology includes the words noted above, derivatives thereof and words of similar import.

The types of model aircraft compatible with the present invention are those which are capable of hovering, such as helicopters and multirotor multicopters (such as quadcopters). The term multicopter shall be used hereafter to refer to any such compatible aircraft.

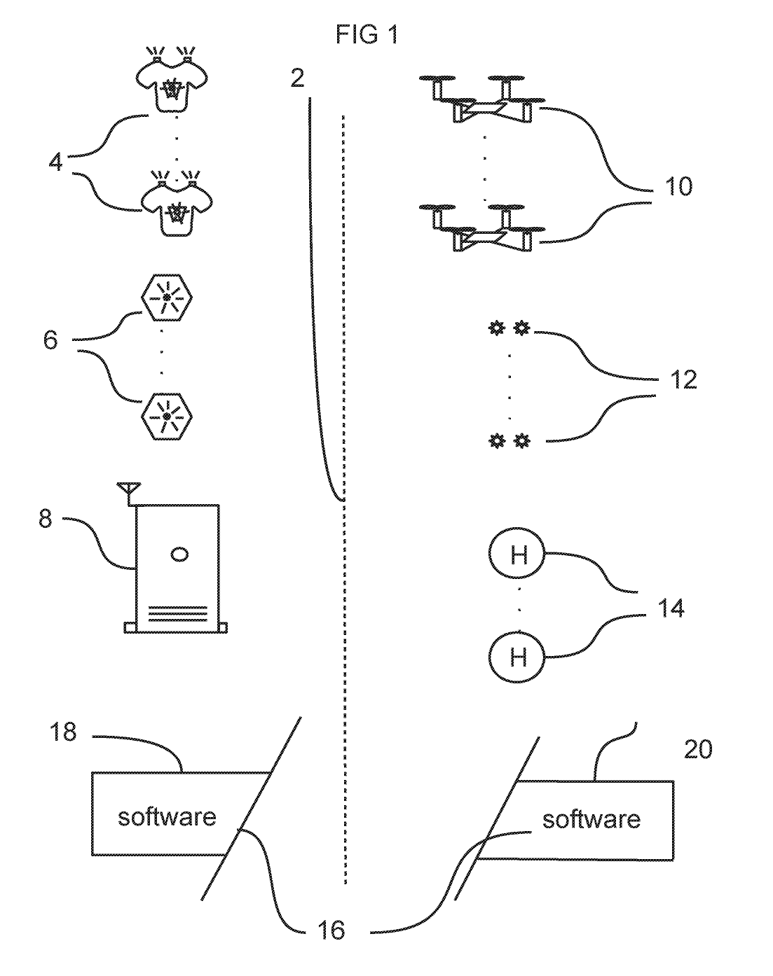

FIG. 1 is a diagrammatic view of the elements comprising a light-tag system incorporating multicopters as non-human players. The system comprises the traditional elements of conventional light-tag on the left side of dividing line 2 and the novel addition of computer-controlled, multicopter players on the right of dividing line 2. On the left are one or more human-worn vest-packs 4, zero or more (optional) fixed position light-tag “bases” 6 and central game control computer 8. On the right is the novel element of one or more computer-controlled multicopter 10 incorporating the necessary elements to participate in the game. Also on the right are the navigation markers 12 and charging station landing pads 14. Game control application software 16 which runs on central game control computer 8 may be split into traditional software module 18 and multicopter support software module 20.

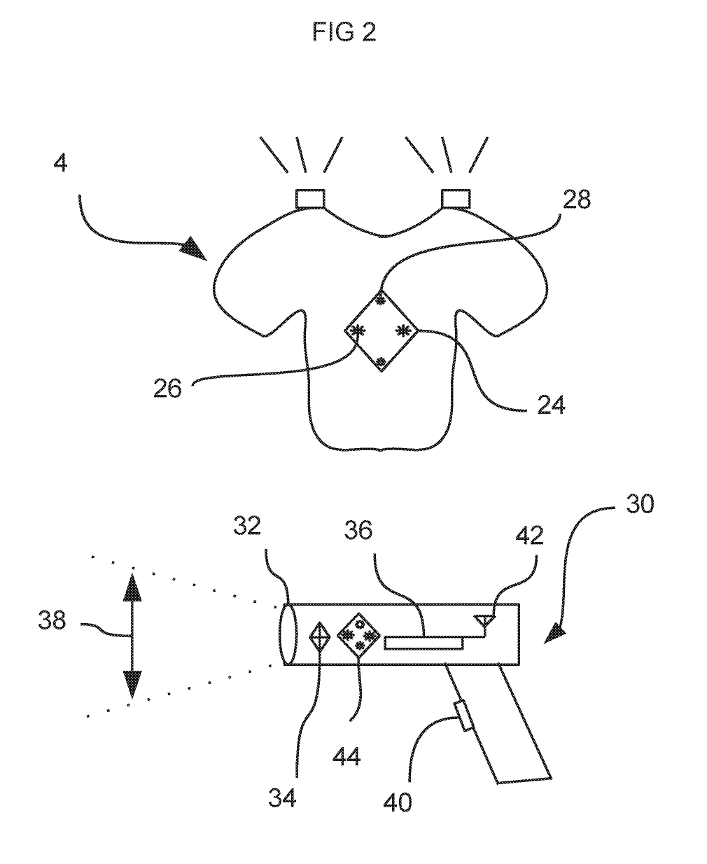

FIG. 2 is a diagrammatic view of a vest-pack design which may be used with embodiments of the invention. Vest-pack 4 has distributed on its surfaces one or more targets 24 each comprising active infrared coded-light emitters 26 co-located with one or more multi-color LED light emitters 28 which enable vest-pack 4 to be seen and “shot” by opponents. Associated shooting device 30 (which may also be termed a “targeting device” or “detecting device” as shooting device 30 does not actually emit or propel anything) contains light-collecting and focusing optics 32 and infrared light detector 34 which allows electronics module 36 to detect and identify an opponent target 24 in optical field of view 38. The shooting device 30 may also comprise one or more targets 44 (such as on opposing exterior side walls of the shooting device 30). One or more stationary targets (not illustrated) may be placed at various locations around the arena. When trigger 40 is activated by a human player while a target (either a target on an opponent's shooting device or vest-pack or a target on an aircraft, as described below) is in the field of view 38 and is thereby detected by the infrared light detector 34, connected electronics module 36 then transmits (either directly or through an intervening device, such as a central computer, router, etc.) via radio module 42 an “I shot you” signal to the opponent's corresponding radio module 42 and thereby electronics module 36 (or to the similar components of the aircraft, as described below), which then reacts in a way consistent with the particular game rules in force according to the game variant being played (for example, an opponent that receives an “I shot you” signal may illuminate one or more lights on the vest-pack or shooting device to indicate to other players that the opponent has been “shot,” and/or the shooting device of the opponent that receives an “I shot you” signal may be disabled for a predetermined length of time).

The shooting device may be tethered to its associated vest-pack, with communication, control, and/or power wires in the tether. In this regard, for example, a single battery pack may be housed in the vest-pack and power both the vest-pack and shooting device, or vice versa. Additionally, a single electronics module may be housed in the vest-pack and control the operation of both the vest-pack and shooting device, or vice versa.

The electronics module 36 (which may also be termed a controller) may be comprised of a microprocessor, dedicated or general-purpose circuitry (such as an application-specific integrated circuit or a field-programmable gate array), a suitably programmed computing device, or any other suitable means for controlling the operation of the device.

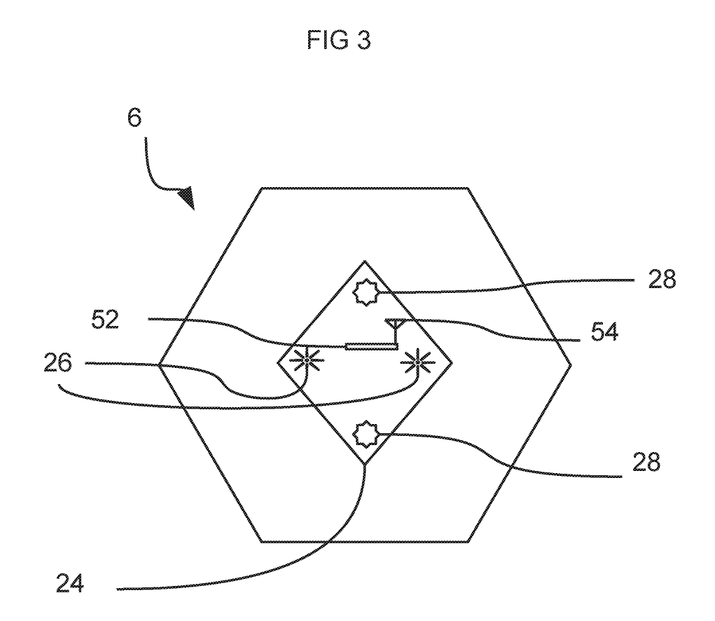

FIG. 3 is a diagrammatic view of a fixed-position base which may be used with embodiments of the invention. Base 6 has distributed on its surfaces one or more targets 24 each comprising active infrared coded-light emitters 26 co-located with one or more visible light emitters 28 which enable base 6 to be seen and “shot” by opponents. Electronics module 52 is able to receive via radio module 54 an “I shot you” signal from an opponent, which enables base 6 to react appropriately (for example, a base that receives an “I shot you” signal may illuminate one or more lights to indicate to other players that the base has been “shot”). The electronics module 52 (which may also be termed a controller) may be comprised of a microprocessor, dedicated or general-purpose circuitry (such as an application-specific integrated circuit or a field-programmable gate array), a suitably programmed computing device, or any other suitable means for controlling the operation of the device.

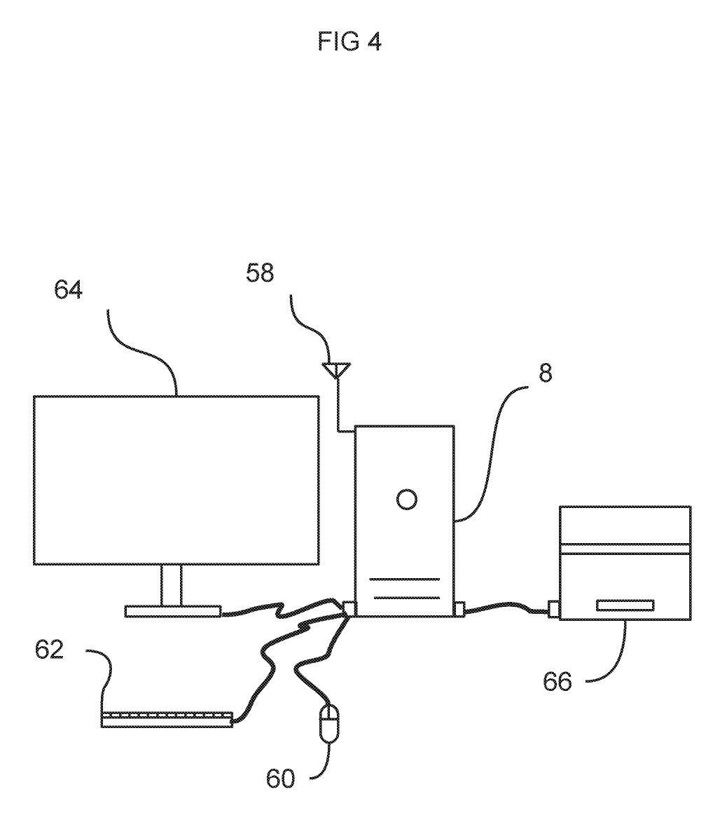

FIG. 4 is a diagrammatic view of a game control computer which may be used with embodiments of the invention. Game control computer 8 is able to communicate with all of the other game elements via its radio module 58 (which may be, for example, a commercial off the shelf USB radio module). With a conventional mouse 60, a keyboard 62, a monitor 64, a printer 66 and appropriate application software, game control computer 8 performs the traditional function of defining the game rules, game timing, collecting scores and printing scorecards. As part of the invention, game control computer 8 has the additional task of directing and coordinating the multicopter behavior between and during games.

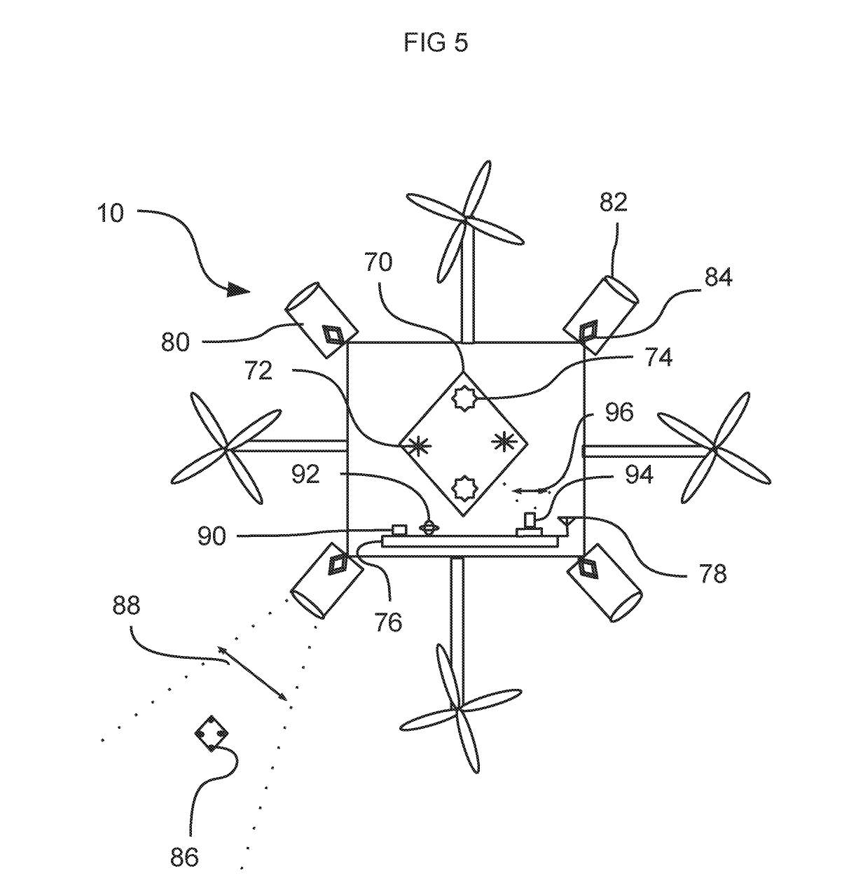

FIG. 5 is a diagrammatic view of a computer-controlled multicopter which may be used with embodiments of the invention. Since a multitude of public-domain physical, electronic and software designs for small, battery-powered multicopters are available on the Internet, specifics as to those topics are not cited here. Multicopter 10 includes one or more targets 70 each comprising an active infrared coded-light emitter 72 co-located with one or more multi-color LED light emitters 74 which enables multicopter 10 to be seen and “shot” by opponents. Electronics module 76 is able to receive via radio module 78 an “I shot you” signal from an opponent, which enables multicopter 10 to react appropriately. The electronics module 76 (which may also be termed a controller) may be comprised of a microprocessor, dedicated or general-purpose circuitry (such as an application-specific integrated circuit or a field-programmable gate array), a suitably programmed computing device, or any other suitable means for controlling the operation of the device.

Added to multicopter 10 are one or more shooting devices 80 (which may also be termed “targeting devices” or “detecting devices” as shooting devices 80 do not actually emit or propel anything), each incorporating light-collecting and focusing optics 82 and infrared light detector 84 which allows electronics module 76 to detect and identify opponent targets 86 (which may be a target on a player's vest-pack or shooting device) in optical fields of view 88. An opponent target 86 in the field of view of one of the shooting devices causes a signal to connected electronics module 76 which then decides, in accordance with the current game rules, whether or not to transmit (either directly or through an intervening device, such as a central computer, router, etc.) via radio module 78 an “I shot you” signal to the opponent device which then reacts appropriately (for example, an opponent that receives an “I shot you” signal from an aircraft may illuminate one or more lights on the vest-pack or shooting device to indicate to other players that the opponent has been “shot,” and/or the shooting device of the opponent that receives an “I shot you” signal may be disabled for a predetermined length of time). The decision as to whether to transmit an “I shot you” to another device will depend, for example, upon whether the shooting device is temporarily disabled due to being shot itself, whether the targeted device is on the same team, and/or whether the trigger pull occurred close enough in time to the target signal reception to be considered a fair hit.

As is customary in model multicopters capable of hovering, electronics module 76 includes electronic accelerometer 90 and electronic gyroscope 92 devices and software which enable its flight to be stable without human control. These devices provide the sensory information for inference of values for the craft's yaw, pitch, and roll and translational acceleration which are sufficient to stabilize the craft but are not sufficient to determine its position or to direct its travel. Outdoor autonomous multicopters typically navigate with the assistance of an additional global positioning system (GPS) reception capability, but that technique is not suited for small indoor spaces under metal roofs (which are likely venues for embodiments of the invention to operate).

It is an object of the invention that the multicopter be able to navigate autonomously or semi-autonomously in its indoor light-tag arena. (Even if operating autonomously, the multicopter is still typically operating according to parameters, guidance, etc. that has been established in advance or is established or changed during operation (such as operating within a defined tunnel as described below). The multicopter may receive some operating instructions or input from a central computer and/or a user, but the multicopter's specific flight path is not being controlled/determined by an entity external to the multicopter.) The basis for this capability is small electronic imaging device 94 such as a CMOS digital camera module similar to those found in smart phone devices. Electronic imaging device 94 is part of or connected to electronics module 76, to which electronic imaging device 94 sends a stream of image frames containing, among other things, images of recognizable physical objects with physical positions known by the multicopter software. From these reference objects and their relative position within the field of view 96, each multicopter is able to infer its own critical navigational values of position, velocity, and heading, using mathematical equations such as those published for nautical and spacecraft navigation. In various embodiments, imaging device 94 could be aimed to see visual objects such as ceiling lighting, fixed room features, painted patterns, visible light beacons, infrared light beacons, or floor features that then serve as navigational reference point information.

Traditional image processing involves threshold inferences, edge-detection, pattern recognition and other high bandwidth, computationally intensive techniques. It is an objective of the invention that the multicopter computational hardware required to quickly analyze successive digital images be simple, economical and lightweight.

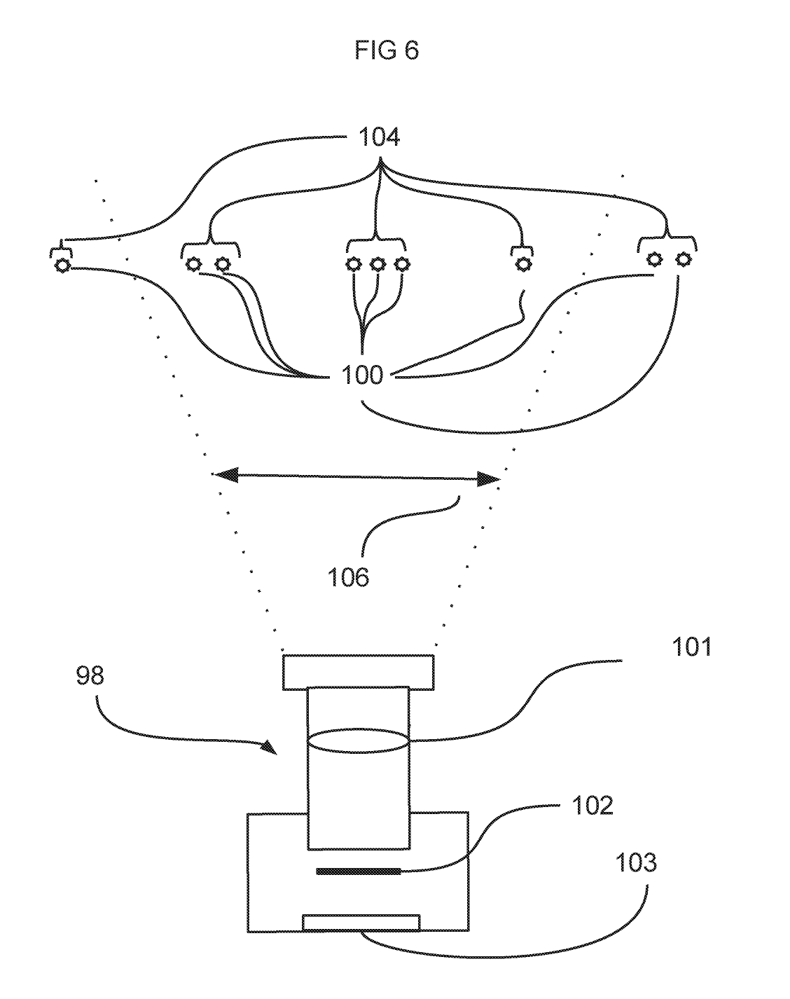

FIG. 6 illustrates a method for constructing and using a system of ceiling navigational light beacons in an embodiment of the invention. Electronic imaging device 98 is aimed upward toward the ceiling of the light-tag arena where low-voltage infrared light emitting diodes (LEDs) 100 are placed in known positions and patterns to serve as navigational reference points. Within the images transmitted by imaging device 98, the LEDs appear as very few pixels. An optical filter 102 placed between lens 101 and image capture chip 103 which passes only infrared light is a necessary part of electronic imaging device 98, allowing electronic imaging device 98 to ignore any ceiling lighting in the visible spectrum present.

To eliminate the requirement for computationally intensive multi-frame object tracking by the multicopter, it is an additional objective of the invention that any multicopter be able to determine its position from one upward image frame at any location. To this end, the LEDs 100 are organized into beacon clusters 104 of LEDs forming recognizable patterns which do not repeat or repeat only at distances too large to cause ambiguity in the inferred position. The only subsequent pattern recognition processing required is the relatively insignificant software chore of grouping the LED's 100 images into their beacon clusters 104 by their relative proximity to one another.

The normal field of view 106 of electronic imaging device 98 is sized to span at least two beacon clusters 104 when the multicopter is operating in its preferred operating space. From an image containing two beacon clusters 104 and the multicopter's knowledge of its recent position, it is relatively simple for the multicopter's software to unambiguously locate those beacon clusters 104 on an internally stored map, as long as any repeating cluster patterns are sufficiently separated in physical distance from one another.

From the image coordinates of the beacon clusters 104 and the known physical coordinates associated with them on an internally stored map, it is feasible to mathematically compute the proximity to the ceiling (and therefore altitude), the azimuth orientation, and a reasonably accurate estimate of the horizontal coordinates. From two successive images and the knowledge of the time between them, the values of climb rate and horizontal translational velocity values can be inferred. These values are then used to continuously correct for the drift in the high speed estimates of the same values that are commonly computed in multicopters by numerical integration of the gyrocompass and accelerometer readings.

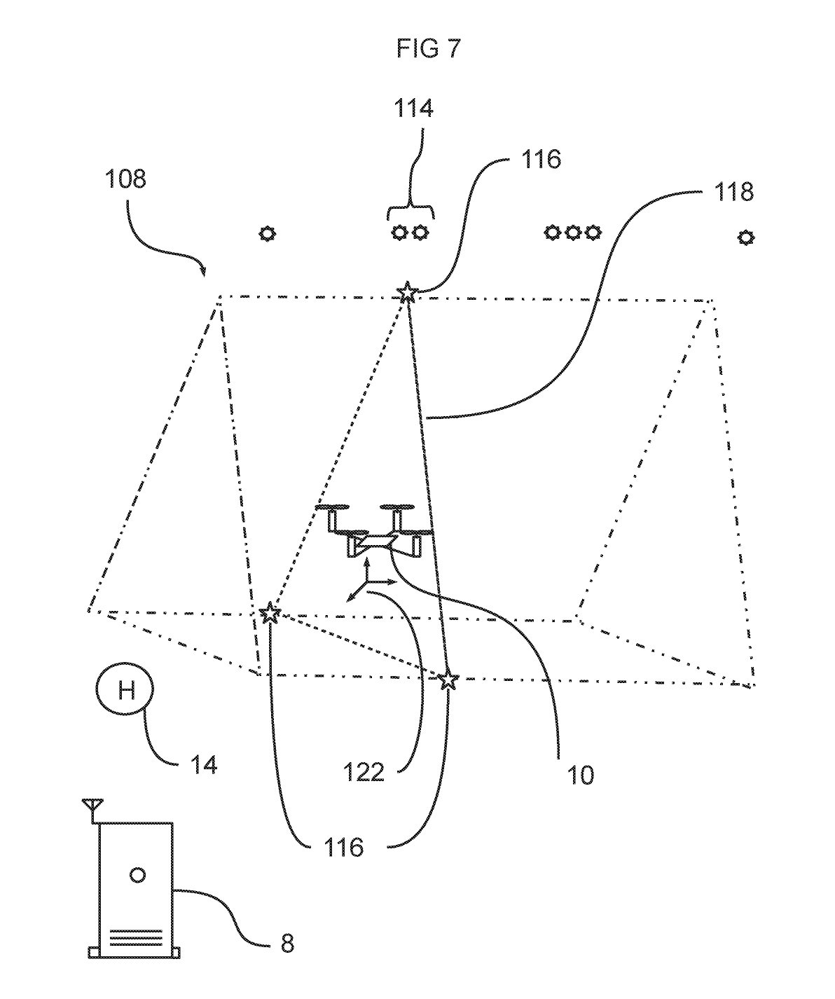

FIG. 7 is a diagram of a “mathematical tunnel in the air” (tunnel) 108 control strategy which may be used with embodiments of the invention for performing the air traffic control function of the multicopters 10. It is an objective of the invention to allow the greatest autonomy possible to the multicopters as they engage the human players while preventing them from colliding with one another or physical obstacles. The central game control computer 8, charged with managing all aspects of the light-tag game, typically must perform the additional task of directing the multicopters' position and preventing collisions by radio messages.

While it is possible to create a system in which the multicopters 10 continually report back their positions, headings, and planned heading changes to central game control computer 8, such a system is necessarily complex with high radio bandwidth requirements. Another shortcoming is that the consequence of garbled communications or navigational errors is collisions. It is an object of the invention to avoid such problems with a design that will eliminate the need for a multicopter to be aware of the existence of its peers or to accommodate them.

In one or more embodiments of the system, tunnels 108 are created as predefined sequences of three-dimensional position coordinates using the same physical Euclidean coordinate system that defines the navigational references (LED clusters 114). Tunnels 108 are in effect roadways for the multicopters, with sequentially numbered waypoints 116 defined their along their top analogous to real roadway mile markers. The waypoints 116 and their associated points forming cross-sectional triangles 118 (other geometric shapes are possible) collectively define a volume in which a multicopter 10 may roam while avoiding fixed obstacles. These numerical maps are stored within each multicopter 10.

Prior to the game, one tunnel 108 may be selected for all of the multicopters 10 to follow, or multiple tunnels 108 may be selected (with each multicopter 10 having its own tunnel 108 or two or more multicopters 10 sharing at least one of the tunnels 108).

Before and occasionally (as needed) during a game, each multicopter 10 receives by radio specifications for a mathematical equation that enables multicopter 10 to continually compute its assigned coordinates for its center of operation 112 within its assigned tunnel 108. Multicopter 10 then is free to maneuver within tunnel 108 while remaining within a specified maximum distance from center of operation 112. It is the job of central game control computer 8 to create different equations for each multicopter 10 so that minimum craft separation distances are maintained at all times.

A simple and practical implementation of the above equation for an embodiment employing only a single tunnel 10 is one in which center of operation 112 is sequentially set to the numbered way-points 116 by a linear equation of time. The waypoint number (with a fractional addition) is computed by a constant multiplied by elapsed flight time from takeoff. The fractional addition is mathematically interpolated: e.g., a computed waypoint number of 22.45 would be 0.45 of the way between waypoint number 22 and way point number 23. Separated by their different take-off times, multicopters 10 sharing a tunnel 108 then would progress at the same average speed and inherently avoid one another. More sophisticated embodiments could incorporate multiple tunnels 108 that may narrow vertically as they cross one another, special times for crossings, and even parallel tunnels 108 for coordinated “formation” flight patterns on command.

Relatively simple logic can serve the function of multicopter's 10 apparent “hunting intelligence”. Although the only limitation is the ambition and imagination of the software author, the minimum requirement is simple. The target position of the multicopter at any time is specified as the vector sum of center of operation 112 and a random vector position offset that is constrained to be within the confines of tunnel 108. Decisions as to whether to send “I shot you” radio signals to adversaries whose infrared coded-light emitters are detected by one of the on-board detectors would then depend upon the game rules in force and human playing difficulty desired. Multicopter 10 behavior when shot (or “stunned”) is typically going “dark” visually and not shooting, but this can vary with game rules in force as well.

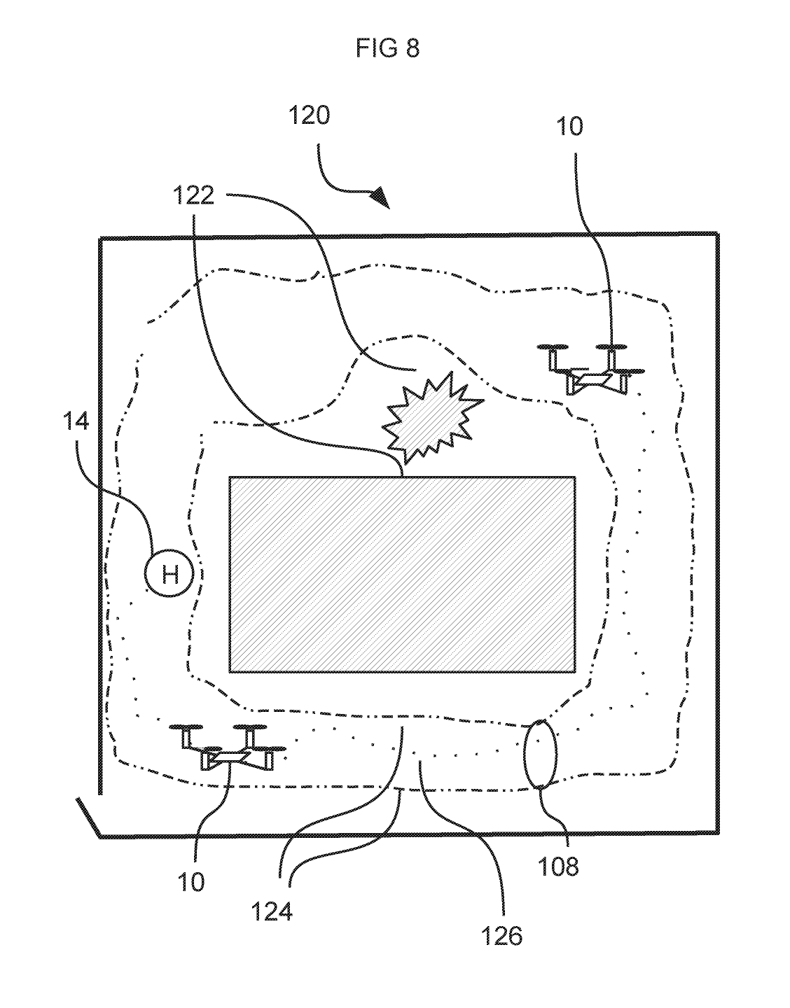

FIG. 8 provides an overhead view of a typical flight path for the multicopter 10. Within the arena 120 are obstacles 122 that the multicopter 10 must avoid during flight. The side limits 124 formed by cross-sectional triangles 118 of the tunnel 108 provide horizontal limitations of the multicopter 10 path, guiding the multicopter 10 within the arena walls 120 while avoiding obstacles 122. Each multicopter 10 takes off from one or more landing pads 14 and begins its flight path 126 around the arena 120 while maneuvering within the boundaries of tunnel 108. Not depicted in this overhead view is the additional vertical constraint placed on the multicopter 10 flight path by the vertical components of the three-dimensional cross-sectional triangles 118.

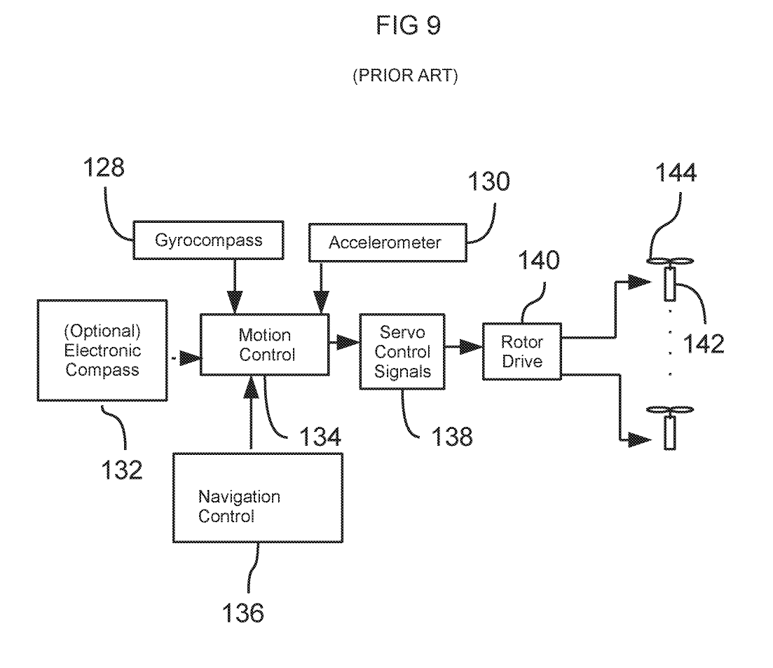

FIG. 9 is a functional diagram denoting a specific portion of the prior art of unmanned physical and computational elements common to unmanned multirotor multicopters. This prior art, a software module entitled “Conventional Multirotor Propulsion SubSystem” is described because its function is intimately involved in the description of the novel art. Gyro 128 is typically an integrated circuit with internal physical devices and internal electronic circuitry which provide real-time information about the multicopter's physical rate of rotation about the three Euclidean axes. Accelerometer 130 is typically an integrated circuit with internal physical devices and internal electronic circuitry which provides real-time information about the multicopter's acceleration along each of the three Euclidean axes. Optional Electronic Compass 132 can provide rough heading information, however magnetic fields from the arena electrical systems and/or the multicopter electric motors can make this information untrustworthy. Some versions of these devices are combinations of the three functions into one integrated circuit.

Motion Control software module 134 accepts as input the actual readings from Gyro 128, Accelerometer 130 and optionally, Electronic Compass 132. Motion Control software module 134 also accepts as input desired values for these readings from a Navigation Control 136 (which in outdoor multicopters typically is a program following a GPS path). This module then generates appropriate servo control signals 138 for rotor drive 140 which then supplies the power to physical motors 142 which produce aerodynamic thrust via rotors 144. The mathematically sophisticated but publicly well-documented algorithms of this module implement feedback control loops to stabilize and direct the orientation and movement of the multicopter. Many implementations of this prior art are very well described in documents in the public domain.

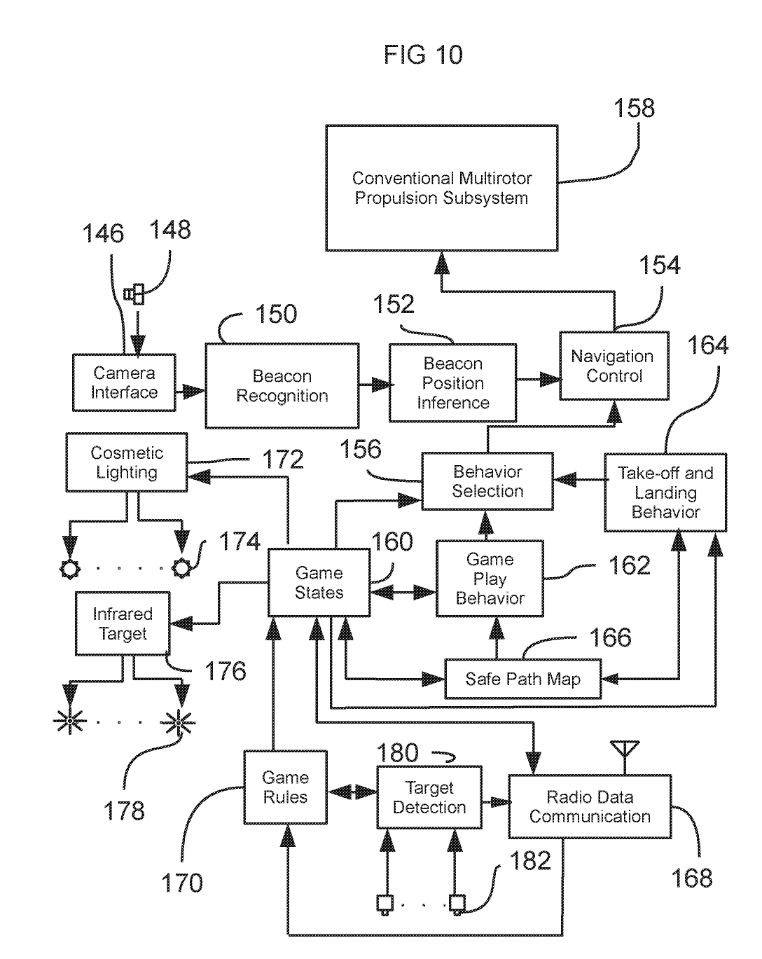

FIG. 10 depicts novel the software modules whose function are typically implemented to create an autonomous multicopter capable of participating in a light-tag game with human players in accordance with embodiments of the invention. Broken into these identified components and their functions, their software implementation was and is a straightforward programming exercise.

Camera Interface software module 146 must be capable of receiving the camera image data from Electronic Image device 148 at a frame rate sufficient for navigational purposes. The Beacon Recognition module 150 processes the images from Camera Interface software module 146 so as to recognize specific lights or other features in the play arena that serve as markers with known physical locations (as described in FIG. 6). Beacon Position Inference module 152 accepts image position information for multiple beacons from Beacon Recognition module 150 and from the image position information mathematically computes the multicopter position and orientation. Navigation Control module 154 accepts the actual position information from Beacon Position Inference module 152, orientation and movement commands from Behavior Selection module 156, and sends orientation and movement directives to existing art Conventional Multirotor Propulsion Subsystem module 158 (described in FIG. 9) which executes the orientation and movement directives. Under the direction of Game States module 160 (described in more detail below), Behavior Selection module 156 forwards path and movement commands from either Game Play Behavior module 162 or Takeoff and Landing Behavior module 164. When selected, each of those modules generates orientation and movement commands compliant with the time-dependent nominal safe position constraints continuously supplied by Safe Path Map module 166, which implements the tunnel scheme of FIG. 7.

Game States module 160 holds a central coordination role, selectively activating behaviors in the other modules and modifying its internal states according to outside events. Game States module 160 has a close connection with Radio Data Communication module 168, allowing Game States module 160 to coordinate the multicopter behavior with other multicopters, human players and the central game-control PC. Game States module 160 references the current game rule set active in Game Rules module 170 as Game States module 160 processes events and changes its states, causing the multicopter to behave appropriately during the particular game variant being played. Game States module 160 shares the system states with Cosmetic Lighting module 172 which then controls the multicopter external lights 174 for human viewing benefit. Likewise, Game States module 160 shares the system states with Infrared Target module 176, which, when appropriate, drives infrared LEDs 178 with unique identification coded-light signals to enable the multicopter to be “shot”. Target Detection module 180 accepts as inputs electrical pulses from one or more directional infrared receivers 182, thereby receiving from other objects their unique identification code which allows them to be “shot” by the multicopter. Game States module 160 consults with Game Rules module 170 before optionally sending “I shot you” message to an opponent via radio.

While the descriptions of embodiments herein are of an implementation ready for commercial launch, there are several feasible variations in the multicopter navigation subsystem which could stand in for the one described. One system, already implemented in sophisticated ground robots and very well documented in published research, would be based upon a panoramic, 360 degree camera incorporating a conical mirror and peripheral visual references. Another would be a system of high-speed, high-resolution fixed cameras around the arena with video outputs used to triangulate the position of multicopters in their fields of view. Yet another could be based upon a system of fixed-position, synchronized rotating lasers like those used for road and runway construction equipment. While all of these are feasible and could be incorporated as a subsystem of invention, the subsystem chosen and described fit best the needs for light-weight, low-power, low-complexity, and low-cost.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A light-tag system comprising:
a human-wearable garment comprising at least one target;
a human-controlled targeting device associated with the garment; and
a computer-controlled aircraft comprising at least one target and at least one targeting device;
wherein each of the at least one aircraft targeting devices is adapted to detect if one of the at least one garment targets is in the respective field of view of the at least one aircraft targeting device; and
wherein the human-controlled targeting device is adapted to detect if one of the at least one aircraft targets is in the field of view of the human-controlled targeting device when the human-controlled targeting device is activated by a user.

2. The system of claim 1, wherein the human-wearable garment is a first human-wearable garment; wherein the human-controlled targeting device associated with the garment is a first human-controlled targeting device associated with the first garment; wherein the system further comprises:
a second human-wearable garment comprising at least one target; and
a second human-controlled targeting device associated with the second garment;
wherein the first human-controlled targeting device is adapted to detect if one of the at least one targets of the second human-wearable garment is in the field of view of the first human-controlled targeting device when the first human-controlled targeting device is activated by a first user; and
wherein the second human-controlled targeting device is adapted to detect if one of the at least one targets of the first human-wearable garment is in the field of view of the second human-controlled targeting device when the second human-controlled targeting device is activated by a second user.

3. The system of claim 1, wherein, if an aircraft targeting device detects that one of the garment targets is in the field of view of the aircraft targeting device, the aircraft targeting device is adapted to selectively transmit a coded message to the garment and/or the targeting device associated with the garment, the coded message informing the garment and/or the garment targeting device that the aircraft targeting device detected the garment target.

4. The system of claim 1, wherein, if the human-controlled targeting device detects that one of the aircraft targets is in the field of view of the human-controlled targeting device when the human-controlled targeting device is activated by a user, the human-controlled targeting device is adapted to transmit a coded message to the aircraft, the coded message informing the aircraft that the human-controlled targeting device detected the aircraft target.

5. The system of claim 1, wherein the human-controlled targeting device comprises at least one target.

6. The system of claim 1, wherein each target of the human-wearable garment and each target of the aircraft emit coded infrared light.

7. The system of claim 1, wherein the aircraft is adapted to navigate about a three-dimensional game space by optically locating one or more light-emitting reference beacons and/or one or more objects in the game space and/or one or more visual features of the three-dimensional game space.

8. The system of claim 7, wherein the aircraft comprises an imaging module, a memory module, and a controller;
wherein the controller is adapted to compare images captured by the imaging module to a map of the game space stored in the memory module.

9. The system of claim 1, wherein the aircraft is adapted to fly within one or more virtual tunnels defined in a three-dimension game space.

10. The system of claim 9, further comprising:
one or more additional computer-controlled aircraft, each comprising at least one target and at least one targeting device;
one or more additional human-wearable garments, each comprising at least one target;
one or more additional human-controlled targeting devices, each associated with a respective additional garment; and
a central computer in radio communication with each aircraft and each garment;
wherein (i) each aircraft is adapted to fly within its own respective virtual tunnel, or (ii) two or more aircraft are adapted to fly within a shared virtual tunnel.

11. The system of claim 10, wherein the central computer is adapted to communicate an assignment of a bounded section of the one or more virtual tunnels to each respective aircraft, each bounded section being unique to its respective aircraft; and
wherein each aircraft is adapted to fly only within its respective bounded section.

12. The system of claim 11, wherein each bounded section moves relative to its virtual tunnels over time.

13. The system of claim 1, further comprising:
a central computer in radio communication with the aircraft;
wherein the central computer is adapted to communicate a mathematical equation to the aircraft that enables the aircraft to continually compute assigned coordinates for a center of operation; and
wherein the aircraft is adapted to fly within a specified maximum distance from the center of operation.
